(19) United States
(12) Patent Application Publication
(10) Pub. No.: US 2002/0081416 A1
(43) Pub. Date: Jun. 27, 2002

(54) Article and method of making

(76) Inventor: Jonathan Goering, York, ME (US)

Correspondence Address: Ronald R. Santucci, Pitney, Hardin, Kipp & Szuch, LLP, 20th Floor, 711 Third Avenue, New York, NY, 10017, US

(21) Appl. No.: 09/899,330

(22) Filed: Jul. 5, 2001

Related U.S. Application Data
(63) Continuation-in-part of application No. 09/796,942, filed on Mar. 1, 2001.
Application No. 09/796,942 is a continuation-in-part of application No. 09/749,318, filed on Dec. 27, 2000.

(51) Int. Cl. B32B 3/04

(52) U.S. Cl. 428/121; 428/129

(57) ABSTRACT

A sheet of material which is made two dimensional which includes portions that are removed that allows the sheet to be folded to create a three dimensional structure without the need for cutting and darting.

### CROSS-REFERENCE TO RELATED APPLICATIONS

This application is a continuation-in-part of U.S. Ser. No. 09/796,942 filed Mar. 1, 2001 entitled “Reinforced Article and Method of Making” which is a continuation-in-part of U.S. Ser. No. 09/749,318, filed Dec. 27, 2000 entitled “Reinforced Article and Method of Making” the disclosures of which are incorporated herein by reference

### FIELD OF THE INVENTION

The present invention relates to a substrate which is formed into a three dimensional article.

### BACKGROUND OF THE INVENTION

Fiber reinforced composite structures enjoy the benefit of being lightweight while providing mechanical advantages such as strength. However, in many applications, molded plastic, wood or metal structures are preferred due to the cost involved, since they are relatively easy to fabricate. Often times however, articles, such as package or storing crates, are prone to damage due to the rough handling involved or are limited in their stacking ability due to weight and strength considerations. While fiber reinforced composite structures would be more desirable, the expense involved in making a somewhat complex three dimensional (3D) structure is a consideration.

This is because composite structures start off typically with a woven flat substrate of fibers. The substrate then has to be shaped into the form of the article which is then coated with a resin and thermoformed or cured in the desired shape. This may be readily done for relatively flat or smooth surfaces. However, for angled surfaces such as at the junction of the sides, corners and bottoms of a box or crate, cutting or darting is required. This is somewhat labor intensive and adds to the cost of manufacture. For things typically considered to be inexpensive, for example a packaging crate, the added expense may outweigh the benefits of it being reinforced.

While woven 3D structures may be woven by specialized machines, the expense involved is considerable and rarely is it desirable to have a weaving machine dedicated to creating a simple structure.

In addition to creating 3-D structures made out of fiber reinforcement, it is also desirable to make 3-D structures out of 2-D sheet material which may be sheet metal, plastic, cloth, paper, cardboard, etc.

Accordingly, while three dimensional articles, reinforced or otherwise, are desirable in many applications, there exists a need to reduce the cost involved in the method of their manufacture. By doing so it may also allow for their relative mass production and wide spread application.

### SUMMARY OF THE INVENTION

It is therefore a principal object of the invention to minimize or eliminate the need to cut and dart sheets of material for 3D structures.

It is a further object as part of this to simplify the manufacture of such structures and reduce the labor requirement.

These and other objects and advantages will be apparent from the present invention. The present invention is directed toward providing a specially designed sheet of material for a 3D structure. It starts off as a 2D structure that is then formed into a 3D structure, particularly one having deep draws. To provide for this, the sheet of material is formed in a manner that has areas which would gather and distort the edges of the 3D structure which is formed by folding the sheet. The edges of the remaining portions of the sheet which formed the boundary of the removed area can be left as is or can be seamed using methods such as welding, thermal bonding or adhesive bonding.

### BRIEF DESCRIPTION OF THE DRAWINGS

Thus by the present invention its objects and advantages will be realized the description of which should be taken and in conjunction with the drawings wherein:

FIG. 1 illustrates the construction of a flat 2D sheet of material incorporating the teachings of the present invention.

FIGS. 2A-2D illustrates the sequence of folding the sheet to produce deep draws.

FIG. 3 illustrates a 2D sheet having multiple areas removed to create a complex structure upon folding or drawing down.

FIG. 4 is a perspective view of a 3D structure formed from the sheet shown in FIG. 3.

### DETAILED DESCRIPTION OF THE PREFERRED EMBODIMENT

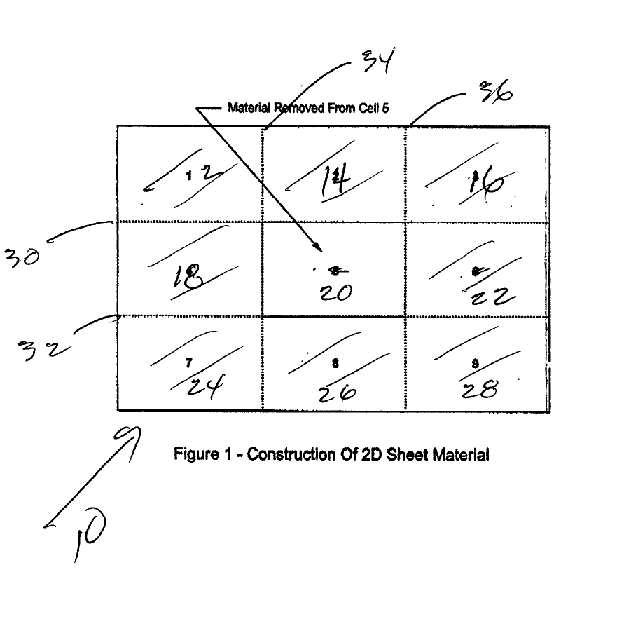

Turning now more particularly to the drawings, like parts will be similarly numbered. In FIG. 1, there is shown a flat 2D sheet of material 10 which illustrates the present invention. The sheet 10 may be made of sheet metal, plastic, cloth, paper, cardboard or any other material suitable for the purpose.

For purposes of this illustration in FIG. 1, the sheet 10 has been divided into regions or areas 12 through 28 divided along fold lines 30-36. The sheet material has either been removed or the sheet formed without it leaving an open space.

Once the sheet 10 is constructed, it can then be formed into the desired shape.

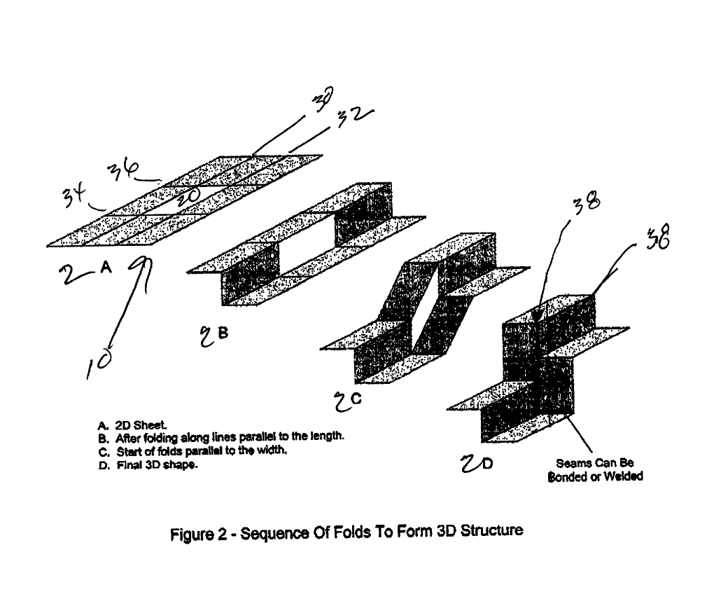

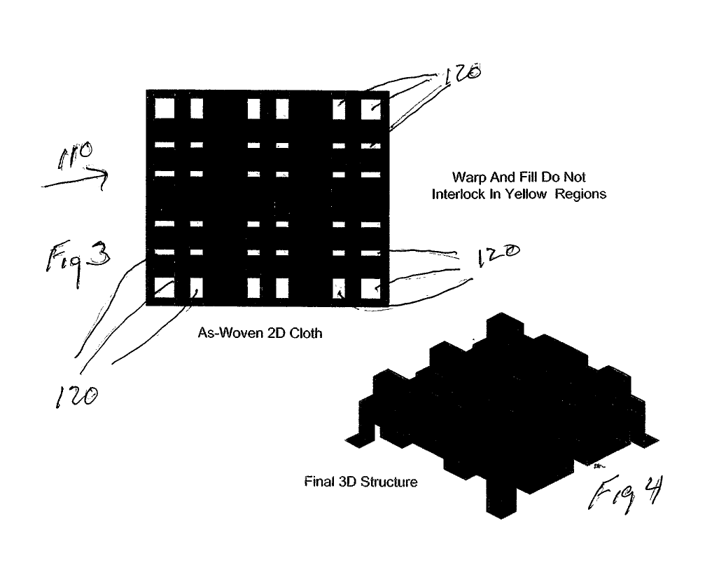

Turning now to FIGS. 2A-2D, shown in FIG. 2A is the flat 2D sheet 10. The sheet 10 is then folded along fold lines 30 and 32. The sheet 10 is then folded along fold lines 34 and 36 which are perpendicular to the fold lines 30 and 32 as shown in FIG. 2C. In this process since there is no material in region 20 the adjacent areas are allowed to be folded into an abutting relationship as shown in FIG. 2D. The edge or corner 38 so formed can be left as is or can be seamed by way of, for example, welding, thermal bonding, adhesive bonding or other means suitable for the purpose. Folding can be done automatically or by other means suitable for this purpose.

The foregoing advantageously avoids the need for cutting or darting, thereby reducing the amount of labor required and the ultimate cost of the article. The present invention allows for the increased automation of the fabrication and therefore broadens the applications for which such structures may be used.

Turning now briefly to FIG. 3 there is shown a flat 2D sheet 110. Sheet 110 illustrates a plurality of regions 120 wherein the sheet material has been removed. With such a sheet 110, it may be folded and shaped into a complex structure 130 as shown in FIG. 4. Of course other shapes can be created by varying the size and location of the regions where the material is removed.

Thus by the present invention its objects and advantages are realized and although preferred embodiments have been disclosed and described in detail herein, its scope should not be limited thereby rather its scope should be determined by that of the appended claims.

What is claimed is:

1. A two dimensional sheet of material for forming a structure having a three dimensional shape, said sheet comprising:
material forming the sheet in a first portion of the sheet;
a second portion of the sheet where material comprising the sheet is removed; and
whereas a folding of the sheet to create a first fold line in a first direction parallel to the second portion, then folding the sheet in a second direction perpendicular to the first direction to create a second fold line causes the second portion to collapse causing the first portion to come into an abutting relationship along the first and second fold lines which creates an abutment.

2. The sheet according to claim 1 wherein the second portion is surrounded by the first portion.

3. The sheet according to claim 1, which includes a plurality of first portions and second portions.

4. The sheet according to claim 3, wherein the second portions are surrounded by first portions.

5. The sheet according to claim 1, wherein the abutment is seamed.

6. The sheet according to claim 5, wherein said abutment is seamed by welding, thermal bonding or adhesive bonding.

7. The sheet according to claim 1, wherein the folding takes place at a junction formed between the first portion and the second portion.

8. A method of making a sheet for forming a structure having a three dimensional shape comprising the steps of:
forming the sheet to create a first portion of the sheet with sheet material;
forming an second portion of the sheet without sheet material; and
folding said sheet in such a manner so as to collapse the second portion by causing the second portion to come into alignment with itself.

9. The method according to claim 8 which includes the step of forming the sheet with the second portion surrounded by the first portion.

10. The method according to claim 8, which includes the step of forming the sheet with a plurality of first portions and second portions.

11. The method according to claim 10, which includes the step of forming the sheet with the second portions surrounded by first portions.

12. The method in accordance with claim 8, wherein the folding of the sheet occurs in a first direction parallel to the second portion and a second direction perpendicular to the first direction which causes the second portion to collapse and creates an abutment in the first portion.

13. The method in accordance with claim 12, wherein the folding takes place at a junction formed between the first portion and the second portion.

14. The method in accordance with claim 12, which includes the step of seaming the abutment.

15. The method according to claim 14, wherein seaming is done by welding, thermal bonding or adhesive bonding.
